(19) United States
(12) Patent Application Publication
(10) Pub. No.: US 2008/0001394 A1
(43) Pub. Date: Jan. 3, 2008

(54) Electrofusion saddle wye

(75) Inventor: Christopher G. Ziu, Lenexa, KS (US)

Correspondence Address: EDWARDS ANGELL PALMER & DODGE LLP, P.O. BOX 55874, BOSTON, MA, 02205, US

(73) Assignee: Orion Enterprises, Inc., Kansas City, KS (US)

(21) Appl. No.: 11/823,066

(22) Filed: Jun. 25, 2007

Related U.S. Application Data
(60) Provisional application No. 60/806,297, filed on Jun. 30, 2006.

(51) Int. Cl. F16L 47/03

(52) U.S. Cl. 285/21.2; 29/428

(57) ABSTRACT

A saddle wye for connecting a branch pipe to a heat fusible thermoplastic main pipe, including a heat fusible thermoplastic saddle shaped and adapted to be received on the main pipe. The saddle includes top and bottom surfaces and an opening extending between the top and bottom surfaces for alignment with an opening in the main pipe. A branch extension extends at an acute angle from the top surface of the saddle such that a first open end of the branch extension is connected the opening of the saddle and a second open end of the branch extension extends above an end of the saddle. A resistance heating wire is secured to the bottom surface of the saddle around the opening of the saddle in a pattern that includes a parabola. The wire pattern assures that fusion occurs close to the opening in the saddle to prevent fluid from reaching between the saddle and a sidewall of the main pipe as fluid travels between the branch pipe and the main pipe.

This application claims priority to U.S. Provisional Patent Application No. 60/806,297, filed Jun. 30, 2006, which is incorporated herein by reference.

### TECHNICAL FIELD OF THE DISCLOSURE

The present disclosure relates to electrofusion couplings and fittings for thermoplastic piping, and more particularly, to a saddle wye for connecting a branch pipe to a main pipe and which includes resistance heating wire for allowing the saddle wye to be joined to the main pipe by electrofusion.

### BACKGROUND OF THE DISCLOSURE

Heat fusible thermoplastic piping has gained widespread use due in large part to thermoplastic's relatively low cost and outstanding performance characteristics. The most common heat fusible thermoplastics include polyethylene (high density and medium density types), and polypropylene (homopolymer and copolymer polypropylene types). Thermoplastic pipes and fittings are ideal for all forms of water transportation, ranging from potable water delivery, to geothermal systems, radiant heating, fire water, plant water, and high purity water systems. Thermoplastic pipes and fittings can be field joined with joints of exceptionally high integrity using electrofusion.

To facilitate easier installation of heat fusible thermoplastic pipes and fittings, a new joining process referred to as “electrofusion” was developed (as described for example in U.S. Pat. Nos. 3,378,672; 3,465,126; and 3,506,519). In general, electrofusion involves embedding or molding a resistance heating wire in joint locations of the pipes and fittings, and then creating heat and fusion by passing electricity through the wire (with pressure applied via external clamping) in order to form joints between the pipes and fittings.

While the advantages of heat fusion have been long known in building interior piping, the ability for pipes to have welds, which have a 0% leak rate has been recently noted by water distribution professionals. Previously, small leaks in the mechanically joined pipe joints of municipal water distribution systems, for example, have been tolerated and accepted as a given. However, since the cost to produce and deliver water has risen dramatically in recent times, there has been a desire to eliminate leaks completely in order to conserve water. Thermoplastic pipes and fittings having electrofusion joints have been recognized as the most cost effective method to eliminate leaks.

Other typically applications for electrofusion joints include corrosive waste and hazardous waste piping, landfill applications, municipal sewers, and other similar drainage applications. A common component of these applications is that the effluent has some corrosive content to it, and that there is a basic need to eliminate leakage at the joints.

In all types of fluid piping systems, there is normally a need to have branch fittings that connect branch (or secondary) lines with a main line. So-called lateral or wye branch fittings connect to the main line at an acute angle, such as 45° and 60°, while tee branch fittings connect at 90°. Wye branch fittings generally produce a smoother transition of flow between the branch line and the main line, which is less likely to result in a fluid back up. Wye branch fittings, therefore, are normally preferred in sewer systems, or other fluid systems where solids may be contained in the fluid.

In pressurized fluid systems, such as municipal water distribution systems, there is also benefit to incorporating wye branch fittings in lieu of tee branch fittings. The comparative pressure drop in a 45° wye branch fitting, for instance, is approximately 30% less than that of a corresponding tee branch fitting of equal size. There is even further frictional loss savings when the branch fitting is of a reduced size compared to the main line. In systems where there are many hundreds or thousands of branches, the cumulative effect of this reduced pressure drop is very significant. Among other advantages and benefits, a significant reduction in system pressure drop through the use of wye fittings allows smaller and cheaper pumps to be used in distribution systems.

It is often desirable to add a branch line to a main line in an existing water distribution system. For example, in a municipal water distribution system a branch line may be added to a main line in order to provide water to a new neighborhood development. Another example is in the repair of sewer lines where thermoplastic pipes are slip-lined into an old deteriorating concrete sewer to replace the old concrete sewer. In these applications, it would be very difficult and costly to excavate, cut into the line, and join a regular branch fitting. Instead, it is much more efficient to utilize a branch fitting consisting of a relatively small saddle, which can be joined to the line without having to excavate a larger hole to accommodate a larger, full size branch fitting.

What is still desired is a new and improved saddle wye for connecting a branch pipe to a main pipe, and that includes resistance heating wire for allowing the saddle wye to be joined to the main pipe using electrofusion. Preferably, the resistance heating wire will be provided in a pattern that provides a more secure and complete fusing between the saddle wye and the main pipe.

### SUMMARY OF THE DISCLOSURE

The present disclosure provides a new and improved saddle wye for connecting a branch pipe to a heat fusible thermoplastic main pipe, and that includes resistance heating wire for allowing the saddle wye to be joined to the main pipe using electrofusion. The saddle wye includes a heat fusible thermoplastic saddle shaped and adapted to fit on a sidewall of the main pipe. The saddle has top and bottom surfaces and an opening extending between the top and bottom surfaces for alignment with an opening in the sidewall of the main pipe. A tubular branch extension extends at an acute angle from the top surface of the saddle such that a first open end of the branch extension is connected the opening of the saddle and a second open end of the branch extension extends above an end of the saddle. The resistance heating wire is secured to the bottom surface of the saddle around the opening of the saddle in a pattern that includes a parabola connected to a semi ellipse.

Among other aspects and advantages, the resistance heating wire pattern provides a more secure and complete fusing between the saddle wye and the sidewall of the main pipe. In particular, the wire pattern assures that fusion occurs close to the opening in the saddle to prevent voids, which might allow fluid to reach between the bottom surface of the saddle and the sidewall of the main pipe as the fluid travels between the branch pipe and the main pipe.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a side elevation view of an exemplary embodiment of a saddle wye constructed in accordance with the present disclosure shown secured to a main pipe;

FIG. 2 is an end elevation view of the saddle wye of FIG. 1;

FIG. 3 is a sectional view of the saddle wye of FIG. 1 as taken along line 3-3 of FIG. 2;

FIG. 4 is an enlarged opposite end perspective view of the saddle wye of FIG. 1;

FIG. 5 is an enlarged bottom plan view of the saddle wye of FIG. 1, showing a resistance heating wire arranged in a predetermined pattern in accordance with the present disclosure; and

FIG. 6 is an enlarged bottom plan view of the saddle wye of FIG. 1, wherein broken lines are provided to illustrate that the predetermined pattern of the resistance heating wire comprises a parabola joined to a semi-ellipse.

### DETAILED DESCRIPTION OF EXEMPLARY EMBODIMENTS

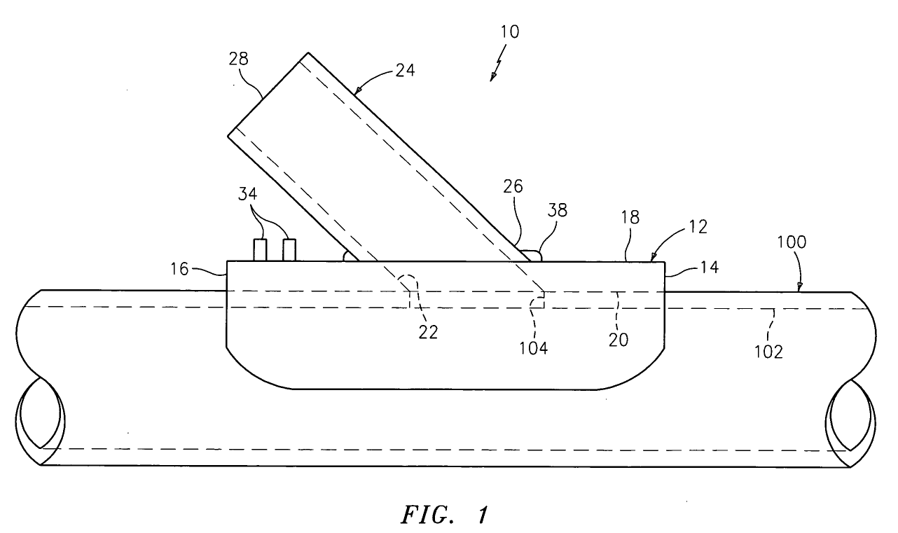

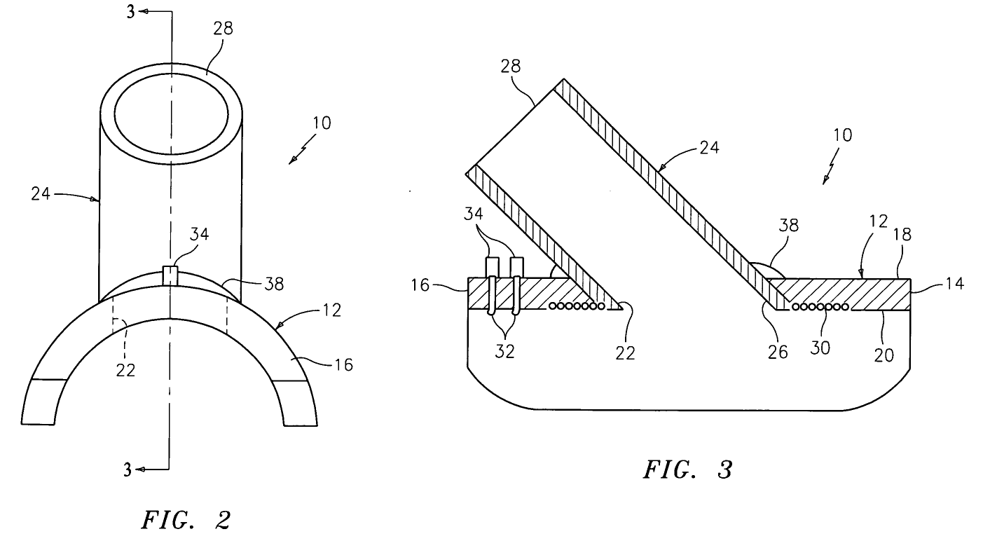

Referring to the drawings, the present disclosure provides an exemplary embodiment of a saddle wye 10 for connecting a branch pipe to a heat fusible thermoplastic main pipe. FIG. 1 shows the saddle wye 10 secured to a sidewall 102 of a main pipe 100. The saddle wye 10 includes a heat fusible thermoplastic saddle 12 extending between first and second ends 14, 16. The saddle 12 is shaped and adapted to coaxially fit on the sidewall 102 of the main pipe 100. As also shown in FIGS. 2 and 3, the saddle 12 includes top and bottom surfaces 18, 20 and an opening 22 extending between the top and bottom surfaces for alignment with an opening 104 in the sidewall 102 of the main pipe 100.

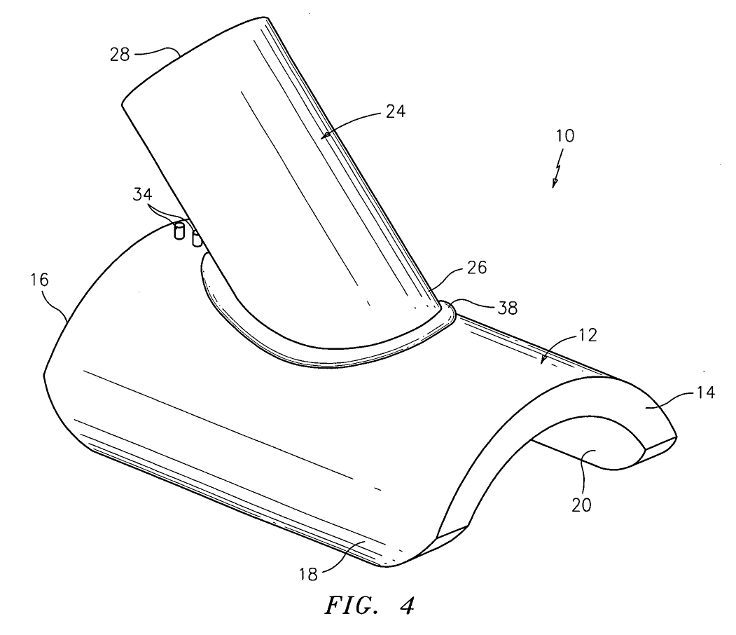

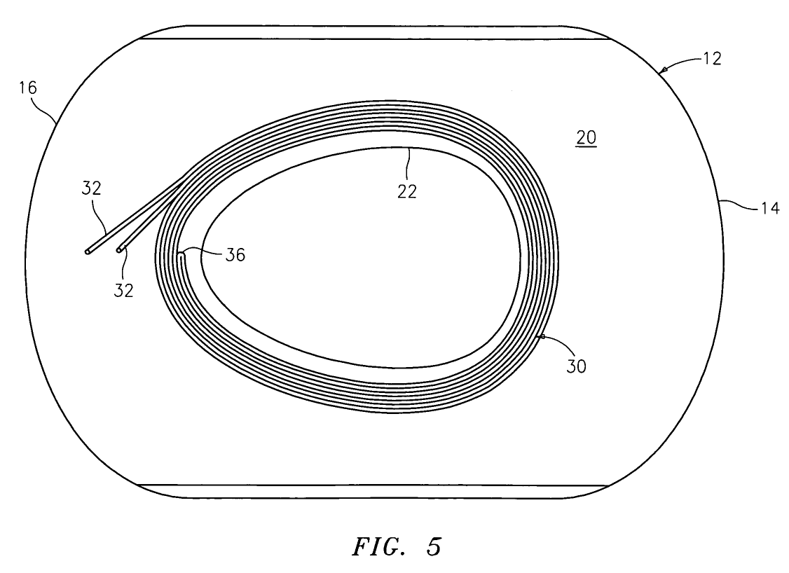

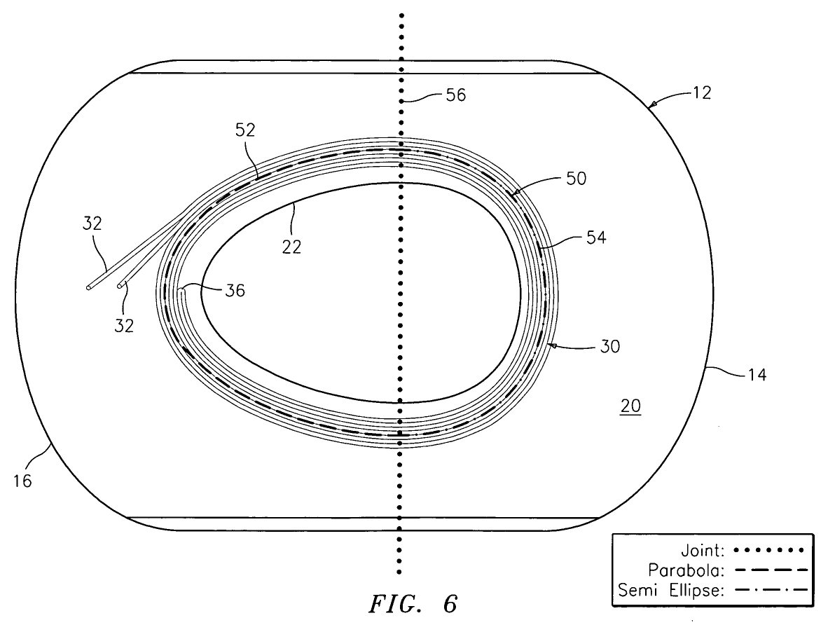

The saddle wye 10 also includes a tubular branch extension 24 extending at an acute angle from the top surface 18 of the saddle 12 such that a first open end 26 of the branch extension is connected to the opening 22 of the saddle and a second open end 28 of the branch extension extends above the second end 16 of the saddle. FIG. 4 shows a perspective view of the saddle wye 10 from the first end 14 of the saddle 12. The branch extension and saddle may be constructed from two separate pieces or molded as a single piece. As shown best in FIGS. 5 and 6, because the branch extension 24 extends at an acute angle a shape of the opening 22 of the saddle 12 generally includes a parabola connected to one of a semi circle and a semi ellipse and the parabola extends towards the second end 16 of the saddle. A semi circle or a semi ellipse will be present depending on the specific angle of the branch extension with respect to the saddle. In the exemplary embodiment of FIGS. 5 and 6, a semi-ellipse is present in the shape of the opening 22 and extends toward the first end 14 of the saddle 12.

A shown in FIG. 5, a resistance heating wire 30 is secured to the bottom surface 20 of the saddle 12 around the opening 22 of the saddle in a predetermined pattern. As illustrated in FIG. 6, the pattern 50 includes a parabola 52 located between the opening 22 and the second end 16 of the saddle 12. The pattern 50 also includes one of a semi circle and a semi ellipse connected to the parabola 52 and located between the opening 22 and the first end 14 of the saddle 12. In the exemplary embodiment of FIGS. 5 and 6, the pattern 50 includes a semi ellipse 54. The semi ellipse 54 has ends that are joined to ends of the parabola 52. A joint line 56 is provided in FIG. 6 to illustrate the connection between the semi ellipse 54 and the parabola 52. In one exemplary embodiment, the resistance heating wire pattern 50 is substantially consistently spaced from the opening 22 throughout its path.

A resistance heating wire pattern 50 constructed in accordance with the present disclosure provides a more secure and complete fusing between the saddle wye 10 and the sidewall 102 of the main pipe 100. In particular, the wire pattern 50 assures that fusion occurs close to the opening 22 in the saddle 12 in order to prevent voids adjacent to the opening between the bottom surface 20 of the saddle and the sidewall 102 of the main pipe 100. Such voids might allow fluid to reach between the bottom surface of the saddle and the sidewall of the main pipe as the fluid travels between the branch pipe and the main pipe. The pattern 50 also helps to minimize the overall size of the saddle 12 required.

As shown best in FIG. 3, leads 32 of the resistance heating wire 30 are connected to electrical contacts 34 extending from the top surface 18 of the saddle 12. As shown in FIGS. 5 and 6, the resistance heating wire 30 comprises a single elongated insulated wire having two non-insulated ends that comprise the leads 32, and wherein the wire is folded upon itself and spirally wound around the opening 22 of the saddle 12 such that a folded end 36 is nearest the opening 22 and the leads 32 are furthest from the opening. The resistance heating wire 30 may be molded into the saddle 12, embedded into the bottom surface 20 of the saddle, or adhered to the bottom surface of the saddle. An example of a suitable method for imbedding the wire is disclosed in U.S. Pat. No. 5,708,251.

In the exemplary embodiment shown, a diameter of the branch extension 24 is less than a diameter of the main pipe 100. In alternative embodiments, the diameter of the branch extension can be equal to a diameter of the main pipe. As shown in FIGS. 1, 3, and 4, the saddle wye further comprises a reinforcing bead 38 between the saddle 12 and the first end 26 of the branch extension 24. The saddle fitting 10 is preferably molded and is manufactured with a substantial enough integral reinforcement around the branch opening to allow the part to form a fully pressure rated arrangement and to allow the part to resist all loads that will be imposed upon it in typical service.

All patents, published patent applications and other references disclosed herein are hereby expressly incorporated in their entireties by reference.

The present disclosure, therefore, provides a new and improved electrofusion saddle wye. It should be understood, however, that the exemplary embodiment described in this specification has been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the saddle wye disclosed herein, and all elements thereof are contained within the scope of at least one of the following claims. No elements of the presently disclosed saddle wye are meant to be disclaimed.

What is claimed is:

1. A saddle wye for connecting a branch pipe to a heat fusible thermoplastic main pipe, comprising:
a heat fusible thermoplastic saddle extending between first and second ends and shaped and adapted to be coaxially received on a sidewall of a main pipe, wherein the saddle includes top and bottom surfaces and an opening extending between the top and bottom surfaces for alignment with an opening in the sidewall of the main pipe;
a tubular branch extension extending at an acute angle from the top surface of the saddle such that a first open end of the branch extension is connected to the opening of the saddle and a second open end of the branch extension extends above the second end of the saddle; and
a resistance heating wire secured to the bottom surface of the saddle around the opening of the saddle in a pattern including a parabola located between the opening and the second end of the saddle.

2. A saddle wye according to claim 1, wherein the resistance heating wire pattern further comprises one of a semi ellipse and a semi circle connected to the parabola and located between the opening and the first end of the saddle.

3. A saddle wye according to claim 1, wherein the resistance heating wire pattern further comprises a semi ellipse connected to the parabola, wherein the semi ellipse is located between the opening and the first end of the saddle.

4. A saddle wye according to claim 1, wherein leads of the resistance heating wire are connected to electrical contacts extending from the top surface of the saddle.

5. A saddle wye according to claim 1, wherein the resistance heating wire is embedded into the bottom surface of the saddle.

6. A saddle wye according to claim 1, wherein the resistance heating wire comprises a single elongated insulated wire having two non-insulated ends that comprise the leads, and wherein the wire is folded upon itself and spirally wound around the opening of the saddle such that the folded end is nearest the opening and the leads are furthest from the opening.

7. A saddle wye according to claim 1, wherein a diameter of the branch extension is equal to a diameter of the main pipe.

8. A saddle wye according to claim 1, further comprising a reinforcing bead between the saddle and the first end of the branch extension.

9. A saddle wye according to claim 1, wherein the pattern is substantially consistently spaced from the opening throughout its path.

10. A pipe assembly including the saddle wye of claim 1 and further comprising:
a main pipe having a sidewall secured to the saddle of the saddle wye via electrofusion using the resistance heating wire secured to the bottom surface of the saddle, wherein the sidewall of the main pipe includes an opening in alignment with the opening of the saddle; and
a branch pipe having an end secured to the second open end of the branch extension of the saddle wye.

11. A method for connecting a branch pipe to a heat fusible thermoplastic main pipe, comprising:
securing resistance heating wire to a bottom surface of a heat fusible thermoplastic saddle such that the resistance heating wire is arranged in a pattern around an opening of the saddle, wherein the pattern includes a parabola connected to one of a semi circle and a semi ellipse;
placing the bottom surface of the saddle on a sidewall of the main pipe so that the opening of the saddle is aligned with an opening in the sidewall of the main pipe; and
applying electricity to leads of the resistance heating wire.

12. A method according to claim 11, wherein the pattern comprises a parabola connected to a semi ellipse.

13. A method according to claim 11, further comprising providing tubular branch extension extending at an acute angle from a top surface of the saddle such that a first open end of the branch extension is connected the opening of the saddle.

14. A method according to claim 13, further comprising securing a branch pipe to a second open end of the branch extension.

15. A method according to claim 13, wherein the saddle extends between a first end and a second end and a second open end of the branch extension extends over the second end of the saddle, and wherein the parabola in the pattern of the resistance heating wire is positioned between the opening of the saddle and the second end of the saddle.

16. A method according to claim 11, wherein the resistance heating wire is embedded into the bottom surface of the saddle.

17. A heat fusible thermoplastic fitting comprising:
a saddle having a curved profile adapted to coaxially fit on a sidewall of a pipe, the saddle extending between first and second ends and including a bottom surface for receipt on the sidewall of the pipe, and an opening extending through the bottom surface, wherein a shape of the opening includes a parabola connected to one of a semi circle and a semi ellipse and the parabola extends towards the second end of the saddle; and
a resistance heating wire secured to the bottom surface of the saddle around the opening in a pattern including a parabola and one of a semi circle and a semi ellipse, wherein the parabola is located between the opening and the second end of the saddle.

18. A heat fusible thermoplastic fitting according to claim 17, wherein the pattern is substantially consistently spaced from the opening throughout its path.

19. A heat fusible thermoplastic fitting according to claim 17, wherein the resistance heating wire is embedded into the bottom surface of the saddle.

20. A heat fusible thermoplastic fitting according to claim 17, wherein the resistance heating wire comprises a single elongated insulated wire having two non-insulated ends that comprise leads, and wherein the wire is folded upon itself and spirally wound around the opening of the saddle such that the folded end is nearest the opening and the leads are furthest from the opening.
